(19) United States
(12) Patent Application Publication
(10) Pub. No.: US 2004/0143437 A1
(43) Pub. Date: Jul. 22, 2004

(54) Sound-activated system for remotely operating vehicular or other functions

(75) Inventor: Scott T. Hanood, Melvern, OH (US)

Correspondence Address: WOOD, HERRON & EVANS, LLP, 2700 CAREW TOWER, 441 VINE STREET, CINCINNATI, OH, 45202, US

(73) Assignee: JBS Technologies, LLC, Steubenville, OH

(21) Appl. No.: 10/752,052

(22) Filed: Jan. 6, 2004

Related U.S. Application Data
(60) Provisional application No. 60/438,244, filed on Jan. 6, 2003.

(51) Int. Cl. G10L 13/00

(52) U.S. Cl. 704/258

(57) ABSTRACT

A hand-held sound-activated system for remotely activating the functions of a vehicle or other item is disclosed. The system provides for an apparatus, such as a key fob, that houses a sound recognition controller and a microphone capable of receiving, comparing, processing, and remotely transmitting a signal to activate a desired function. The apparatus contains a microphone activator, a sound digitizer for digitizing sounds such as passwords and commands into a digital code, a digital memory for storing the digital codes for valid and authorized sounds, a sound recognition comparator for comparing and determining the validity of a subsequently received sound with those stored in the memory unit, and a transmitter for transmitting a signal to the vehicle or building to activate the desired and authorized function. Indicators of successful operation, such as LEDs, may also be included.

### CROSS REFERENCE TO RELATED APPLICATION

The present application claims benefit of U.S. provisional application Serial No. 60/438,244, filed Jan. 6, 2003, the disclosure of which is hereby incorporated herein by reference in its entirety.

### FIELD OF THE INVENTION

The present invention relates to the use of an-apparatus, such as a key fob, to remotely operate a plurality of vehicular or other functions, such as unlocking doors, arming and/or disarming a security system, or remotely starting the vehicle.

### BACKGROUND OF THE INVENTION

It is desirable for many reasons for a user to be able to remotely activate various functions of a motorized vehicle, home, or business. For example, a driver may desire to remotely unlock or even open a vehicle's doors to allow access to the vehicle without the use of keys, or to allow other passengers, such as children, easy access to the vehicle without the assistance of the driver in using a key to unlock and open a passenger door. In addition, in either cold or hot climates, a driver may wish to remotely start a vehicle to allow it sufficient time to heat or cool prior to the driver entering the vehicle. Moreover, it is also often desirous for a driver to be able to remotely activate various vehicular systems, such as the horn, lights, and blinkers, to attract attention or ward off a potential assailant in a hostile or threatening situation. In the context of a home or business, it is often desirable to unlock doors and/or activate or deactivate security systems while approaching the structure. To achieve these objectives, various apparatuses have been designed, typically contained in a key fob, which give a user the ability to activate such functions.

Key fobs containing buttons which a user can activate to operate various features of a vehicle remotely are well known. For example, some key fobs contain a button, or buttons, which lock or unlock a vehicle's doors. Other fobs contain buttons which, when activated, remotely open one or more doors of a vehicle. Other fobs contain buttons which can activate a vehicle's security system, as well as provide a button for a user to attract attention in a panic or emergency situation. Still other fobs contain a button to remotely start a vehicle's engine. Finally, some key fobs contain a combination of the above buttons and their respective functions.

While a typical key fob provides an individual the ability to activate certain vehicular functions remotely, problems still remain with this approach. For example, while a key fob may contain the buttons to activate certain vehicular systems, it is often difficult at night or in other conditions of low light, such as dimly-lit parking garages, for a user to correctly identify which button on a key fob operates which function. In addition, even in daylight or otherwise lit conditions, the icons or labels on a key fob, over time, can wear off, thus leaving a user with no indication of the function associated with a particular button. Further compounding the possible confusion of a user is the fact that not every key fob has all the same buttons, or all the same buttons arranged by function in the same order. In other words, unlike a piano or a computer keyboard, there is no standardization in the industry as to the placement, function, or size of a particular button on a key fob. In fact, key fobs themselves come in different shapes and sizes. Thus, an individual with more than one vehicle, or an individual borrowing or renting a vehicle he or she is unfamiliar with, is still left with the same potentially confusing situation as to which button operates the desired vehicular function.

Moreover, even the well-trained and experienced operator could easily become flustered in a stressful situation, such as walking to a vehicle at night or in a dimly-lit environment, or in any other situation that potentially poses security concerns. Accordingly, a flustered user could easily select the door open button, as opposed to the door lock or panic button, and thus actually increase his or her vulnerability to foul play.

Key fobs with a plurality of buttons to activate various systems, such as arming or disarming a security system, locking or unlocking doors, or opening or shutting doors, can also be confusing to those suffering from a visual or other handicap. For example, a blind individual who is using a key fob to arm or disarm his or her home security system must rely exclusively on the location and field of the particular buttons on the key fob to correctly select the desired function.

There is also an inherent limitation on the amount of buttons or switches a typical key fob can contain. If more functions are desired, more buttons are typically required to be placed on the key fob. Thus, the key fob either becomes larger to contain the additional buttons, or the buttons become smaller. Either alternative will ultimately provide for a key fob or other apparatus that becomes undesirably too large, or the buttons become undesirably too small. Alternatively, various functions could be controlled by activating a combination of the buttons on a fob, but this would only serve to undesirably further complicate the process of remotely activating a desired function.

In addition to the aforementioned problems associated with a typical key fob, there is also the problem with the inherent lack of security associated with a generic key fob. For example, a lost or stolen key fob that has the capability of locking or unlocking doors, or arming or disarming a security system, essentially becomes a key, allowing an intruder easy access to a home, building, and/or vehicle. Similarly, a key fob with a plurality of buttons in the hands of a small child can raise various safety concerns, as a child could unknowingly and unintentionally activate various functions of a vehicle.

In addition, a key fob with a plurality of buttons controlling various functions of a vehicle provides an individual holding the key fob access to all of those same functions. This, however, is less than desirable in situations, such as those involving a small child, where a user may desire to allow the child access to the vehicle, i.e., by unlocking its doors, deactivating its security system, or even opening its doors, but may not want to give a child the ability to remotely start the vehicle or activate the panic mode.

In sum, there is still a need for remotely activating vehicular or other functions without the inconvenience and potential for mistake which accompany the use of-multiple buttons on a traditional key fob. There is also a need to provide for the capability of activating a multitude of functions remotely without adversely increasing the size of the key fob, adversely decreasing the size of a fob's buttons or switches, or otherwise increasing the complexity of the operation. In addition, there remains a need for reducing the possibility of unauthorized access to a vehicle or home by someone who has acquired a lost or stolen key fob, as well as for preventing the unintentional operation of the functions activated by the key fob. There is also a need to provide for various levels of functionality access, depending on who is attempting the remote activation.

### OBJECTS OF THE INVENTION

It is an object of the applicant's invention to improve the convenience and security of remotely activating functions of a vehicle, building, or the like. It is also an objective of the applicant's invention to provide the capability to activate a multitude of functions remotely with an apparatus and components thereof that are easy to operate and of a desirable size and weight. It is another objective of the applicant's invention to minimize the possibility of unauthorized and/or unintentional activation of any functions of a fob that is lost, stolen, or inadvertently activated. It is also an objective of the applicant's invention to provide for various levels of functionality access, depending upon the identity of the remote user.

### SUMMARY OF THE INVENTION

The present invention achieves these objectives by combining a sound recognition system in a hand-held, portable apparatus, such as a key fob. The present invention provides an apparatus, such as a key fob, that houses a sound recognition controller and a microphone capable of receiving, comparing, processing, and remotely transmitting a signal to activate a desired function. More specifically, the apparatus, or key fob, contains a microphone activator such as a button, a sound digitizer for digitizing sounds such as passwords and commands spoken into the microphone into a digital code, a digital memory for storing the digital codes for valid and authorized sounds such as a user's password and function commands, a sound recognition comparator for comparing and determining the validity of a subsequently received sound with those stored in the memory unit, and a transmitter for transmitting a signal to the vehicle or building to activate the desired and authorized function.

The above and other objects and advantages of the present invention will be made apparent from the accompanying drawings and the descriptions thereof.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is an illustration of an operator using a hand-held voice-activated apparatus to remotely transmit a command to a motor vehicle.

FIG. 2 is a schematic of a first embodiment of the present invention.

FIG. 3A is a perspective view of a second embodiment of the apparatus of the present invention.

FIG. 3B is a perspective view of a third embodiment of the apparatus of the present invention in the form of a key fob.

FIG. 4 is a flow chart illustrating the operation of the present invention.

### DETAILED DESCRIPTION OF THE INVENTION

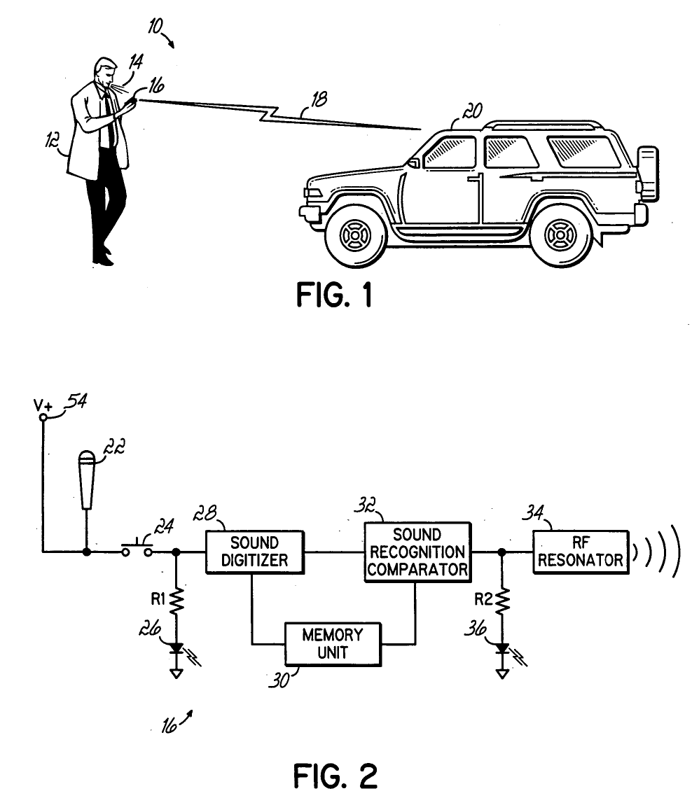

A sound-activated system 10 for remotely operating vehicular or other functions is shown in FIG. 1. An operator 12 is shown speaking 14 into a hand-held apparatus 16 which, in turn, sends a signal 18 to a motorized vehicle 20. While the object 20 that receives the transmitted signal 18 is shown as a vehicle 20, it can be appreciated that the signal 18 could equally be directed to another object 20, such as a house or other structure. In addition, it should be appreciated that a user 12 could input any sound 14 into the apparatus 16, including non-words, whistles, or the like.

The schematic of one embodiment of the hand-held apparatus 16 of the present invention is shown in FIG. 2. As shown, a microphone 22 is activated by a button switch 24. While a button switch 24 is shown, it can be appreciated by those skilled in the art that the microphone 22 could also be activated by a user's 12 voice or other sound 14. FIG. 2 also illustrates that a user 12 may be provided an indication that the microphone 22 is activated by a light-emitting diode (LED) 26 or the like. For example, when the button switch 24 is depressed, a voltage signal flows through resistor R1 to activate the LED 26. In a preferred embodiment, this LED 26 would glow green to indicate to a user 12 that he or she could speak into the microphone 22.

The sound 14 that a user 12 inputs into the microphone 22 is digitized by a sound digitizer 28. Initially, a user 12 could store a unique password or passphrase in a memory unit 30. The memory unit 30 also stores the digitized codes for the functions the apparatus 16 will control. These digital command codes that correspond to various vehicular or other functions, e.g., “OPEN,” “UNLOCK,” “START,” etc., may be entered by a user 12, or may be generically preprogrammed.

The sound-activated apparatus 16 also contains a sound recognition comparator 32 which is able to compare the digital code for any subsequently inputted sound with the digital code for the sounds stored in the memory unit 30. In the case where a password is required, if the digital code for the password stored in the memory unit 30 matches the digitized code for a password subsequently inputted, a user 12 will then be able to input a voice command. Preferably, a green LED may be used to indicate that the password is good and that a user 12 may proceed. If the digital code for the subsequently entered password does not match, a red LED may glow. In alternative embodiments, either multiple LEDs or a single multicolored LED may be used. It should also be appreciated that other feedback indications, such as tones or vibrations, could be used to indicate the validity or invalidity of a password or command.

In alternative embodiments, the password or passphrase may also be required to be spoken by an authorized user 12. In other words, the sound recognition comparator 32 may evaluate not only whether the “magic words” were spoken, but whether the “magic words” spoken also match the voiceprint of the authorized user 12. Finally, the device 16 may be configured to handle frequent and/or repetitive false attempts to input a valid password. For example, the device 16 may go inactive for a period of time, or could even activate an alarm, such as the horn and lights of a vehicle 20.

It should also be appreciated that the sound-activated apparatus 16 may also be configured to operate without the use of a password. In other words, the step of requiring a user 12 to speak a password before speaking a command function could be eliminated, allowing a user 12 to remotely activate a function by simply activating the microphone 22 and speaking the command. In an alternative embodiment, however, security could still be provided by requiring that the command spoken, in addition to being a specific word, e.g., “DISARM,” “LIGHTS,” “HELP,” etc., also matches the voiceprint of the authorized user 12.

If the digital codes for a command action match, a signal 18 is transmitted via a radio frequency (RF) resonator 34 to activate the corresponding function. While an RF resonator 34 is shown, it should be appreciated by those skilled in the art that other types of transmitters could also be used. The apparatus 16 may also contain an LED 36 connected in series with a resistor R2 to provide an indication to a user 12 that the command spoken 14 was valid and the desired function is being activated. In a preferred embodiment, the LED 36 would glow green to indicate a successful operation, and it would glow red to indicate a failure. Alternatively, the LEDs may blink or flash one or more times to provide feedback to a user. For example, if an invalid command is received due to ambient noise, a wrong word spoken, etc., a red LED may blink once. However, after wrong attempts, a red LED may flash several times to indicate to the user 12 that he or she must start over and press the voice activation button 24 again. In alterative embodiments, tones or other indications of a successful or unsuccessful operation could be used.

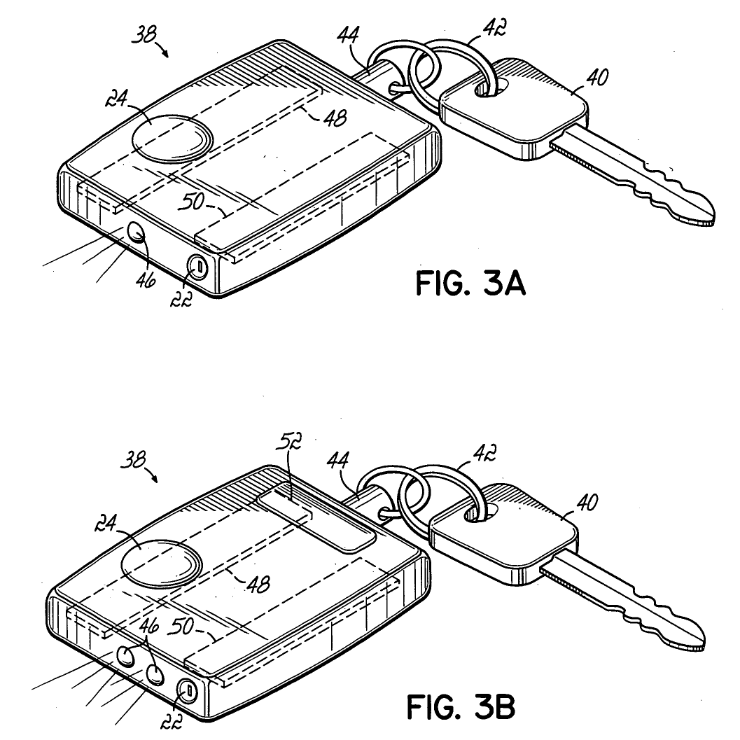

The hand-held apparatus 16 of the present invention in the preferred form of a key fob 38 is shown in FIGS. 3A and 3B. As indicated by the optionally attached key 40, the fob 38 is of such a size as to permit it to be easily carried in a pocket or small purse. While a key 40 may not even be required to be attached to the fob 38, since the fob 38 may be configured to perform the key's 40 function, fobs 38 will still typically contain a key ring 42 secured to a connector 44 of the fob 38 to secure a key 40 or other attachable article, such as another fob.

As shown in FIG. 3A, this fob 38 contains only one button 24 that activates the microphone 22. This embodiment also contains a single, multicolored LED 46 for providing operational feedback to the user 12. The fob 38 also internally contains the various circuitry 48, 50 for the various components herein disclosed. It should be appreciated that the internal configuration of a fob 38 may be adapted in a variety of ways to correspond to the size and shape of the fob 38, the amount of space required by the circuitry 48, 50, and whether such circuitry 48, 50 would optimally be combined on a single circuit board and operatively interconnected in accordance with the principles of the present invention.

As shown in FIG. 3B, in an alternative embodiment, the fob 38 is not limited to only one button 24, but may contain additional buttons 52, as may be desired. The use of an additional button 52 could be reserved for sounding a panic alarm in a situation when the user 12 may be too overcome with fear to even speak. Additionally, the presence of an additional button 52 could be utilized in the initial programming of the fob 38, to enable or disable the requirement for a password, or in combination with the other button 24 to enter a pass code to activate the fob 38.

FIG. 3B also illustrates the presence of more than one LED 46 in this embodiment. As disclosed, it is desirous for a fob 38 to provide feedback to the user 12 with a red and a green LED. Here, two separate LEDs 46 provide that function.

While not shown, it can be appreciated by those skilled in the art that the fob 38 receives its power 54 from a standard fob-type battery. Alternatively, the battery could be configured to be rechargeable via a motion generator contained within the fob 38.

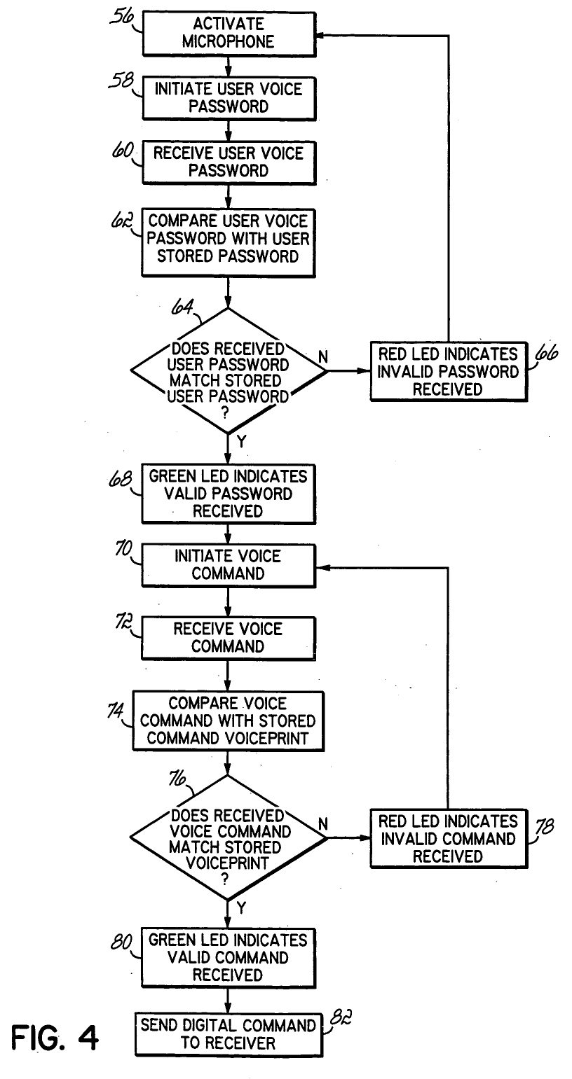

The flow chart shown in FIG. 4 depicts the representative processing performed by the fob 38 or similar hand-held apparatus 16. First the microphone 22 is activated (Block 56). This, as disclosed in the preferred embodiment, is accomplished when the user 12 depresses a button switch 24. In alternative embodiments, the button 24 may be required to be depressed for the entire time of vocalization, or may simply be depressed once to activate the microphone 22 for a preset period of time.

In an embodiment requiring a password, the user 12 next speaks the required password (Block 58), which is received and digitized by (Block 60) the sound digitizer 28. The sound recognition comparator 32 then compares the spoken password with the stored authorized password (Block 62). If the passwords do not match (Block 64), a red LED is illuminated (Block 66). However, if the passwords match, a green LED is illuminated (Block 68) to indicate that the user 12 may now initiate a voice command (Block 70).

The user 12 next speaks a command (Block 70), which would again be received and digitized by (Block 72) the sound digitizer 28. The sound recognition comparator 32 then compares the spoken command with the stored commands (Block 74). If the command does not find a match (Block 76), a red LED is illuminated (Block 78) to inform the user 12 to try again. However, if the spoken command matches a stored command, a green LED is illuminated (Block 80) and a signal 18 corresponding to the command function is transmitted (Block 82).

In an embodiment not requiring a password, or in one where the user 12 has disabled the requirement for a password, the process would begin with the step of the user 12 initiating a voice command (Block 70). Additionally, since alternative embodiments can provide for different passwords for different users, or different biometric voiceprints for passwords or commands associated with different users, the system 10 can be configured to allow for different access to different functions, depending upon who speaks or activates the fob 38. In other words, a child's password or voice may only allow him or her to unlock a door, but not remotely start a vehicle.

Finally, the reader should appreciate that the present invention also encompasses a method for remotely transmitting command signals comprising the steps of activating a microphone for receiving sound, inputting sound into the microphone, digitizing the sound received by the microphone into a digitized code, storing the digitized code for valid sounds received by the microphone, comparing and validating the digitized code of sounds subsequently received by the microphone with the digitized code of valid sounds, and transmitting a signal corresponding to the digitized code of valid sound.

While the present invention has been illustrated by a description of various embodiments and while these embodiments have been described in considerable detail, it is not the intention of the applicant to restrict or in any way limit the scope of the claims to such detail. Additional advantages and modifications will readily appear to those skilled in the art. The invention in its broader aspects is, therefore, not limited to the specific details, representative apparatus and method, and illustrative examples shown and described. Accordingly, departures may be made from such details without departing from the spirit or scope of the applicant's general inventive concept.

What is claimed is:

1. An apparatus for remotely transmitting command signals comprising:
a microphone;
a microphone activator operatively connected to the microphone;
a sound digitizer for digitizing sounds received by the microphone into a digitized code;
a memory unit capable of receiving and storing the digitized codes from the sound digitizer;
a sound recognition comparator for comparing and determining the validity of subsequently received sound digitized codes with those stored in the memory unit; and
a transmitter operatively connected to the sound recognition comparator whereby, upon identification of a valid sound, a signal corresponding to the digitized code is transmitted.

2. The apparatus of claim 1 wherein the microphone activator is a switch.

3. The apparatus of claim 1 wherein the microphone activator is a sound.

4. The apparatus of claim 1 wherein the apparatus is housed in a key fob.

5. The apparatus of claim 1 wherein the sounds are vocalized words.

6. The apparatus of claim 1 wherein the sound recognition comparator further comprises an indicator for indicating the validity of the sounds.

7. The apparatus of claim 6 wherein the indicator is an LED.

8. The apparatus of claim 6 wherein the indicator is a sound.

9. The apparatus of claim 6 wherein the indicator is a vibration.

10. The apparatus of claim 1 wherein the sound recognition comparator must identify both a valid password sound and a valid command sound before the transmitter transmits a signal.

11. An apparatus for remotely transmitting command signals comprising:
a means for receiving a sound input;
a means for activating the means for receiving a sound input operatively connected thereto;
a means for digitizing the sound input into a digitized code;
a means for receiving and storing the digitized codes from the means for digitizing the sound inputs;
a means for comparing and determining the validity of the subsequently received sound input digitized codes with those stored in the means for receiving and storing the digitized codes; and
a means for transmitting a signal corresponding to a subsequently received, valid digitized code.

12. A method for remotely transmitting command signals comprising:
activating a microphone for receiving sound;
inputting sound into the microphone;
digitizing the sound received by the microphone into a digitized code;
storing the digitized code for valid sounds received by the microphone;
comparing and validating the digitized code of sounds subsequently received by the microphone with the digitized code of valid sounds; and
transmitting a signal corresponding to the digitized code of valid sound.
